(19) United States
(12) Patent Application Publication
(10) Pub. No.: US 2024/0036587 A1
(43) Pub. Date: Feb. 1, 2024

(54) METHOD, VEHICLE, SYSTEM AND COMPUTER PROGRAM FOR DETERMINING AND/OR IMPROVING A POSITION ESTIMATION OF A VEHICLE

(71) Applicant: TOP seven GmbH & Co. KG, Starnberg (DE)

(72) Inventor: Ulrich SENG, Starnberg (DE)

(21) Appl. No.: 18/486,841

(22) Filed: Oct. 13, 2023

Related U.S. Application Data
(63) Continuation of application No. PCT/EP2022/059669, filed on Apr. 12, 2022.

(30) Foreign Application Priority Data
Apr. 13, 2021 (DE) 102021203641.4

(51) Int. Cl. G05D 1/02; G01S 19/42

(52) U.S. Cl. CPC G05D 1/0278; G01S 19/42

(57) ABSTRACT

Method for determining and/or improving a position estimation of a vehicle, comprising a step (a) comprising determining at least three distances of the vehicle from at least three signal generators, wherein the respective distance is a distance between the vehicle and one of the at least three signal generators each. Here, the at least three signal generators each comprise a predetermined position with respect to a moving coordinate system, and the moving coordinate system is a coordinate system with respect to which the position of an unmoved object can change due to a movement of the coordinate origin. Further, the method comprises a step (b) comprising determining and/or improving the position estimation of the vehicle by using the at least three determined distances of the vehicle from the at least three signal generators and the predetermined positions of the at least three signal generators with respect to the moving coordinate system.

### CROSS-REFERENCE TO RELATED APPLICATIONS

This application is a continuation of copending International Application No. PCT/EP2022/059669, filed Apr. 12, 2022, which is incorporated herein by reference in its entirety, and additionally claims priority from German Application No. 102021203641.4, filed Apr. 13, 2021, which is also incorporated herein by reference in its entirety.

Embodiments according to the present invention relate to a method, vehicle, system and computer program for determining and/or improving a position estimation of a vehicle. Further embodiments relate to a positioning system by distance measurement accurate to the centimeter using radio waves across distributed radio beacons.

### BACKGROUND OF THE INVENTION

From conventional technology, a plurality of methods with regard to navigation of a vehicle are known, by which the position of the vehicle can be determined. When using GPS, for example, the position can be determined to within a few meters by determining the distances of the vehicle from a plurality of satellites. However, in many cases, a problem with such methods is a lack of accuracy for precise navigation tasks. This problem is further complicated if the vehicle is to be navigated relative to a moving object. For example, if a moving ship or floating oil or gas platform is to be inspected by an autonomous drone, very precise knowledge of the drone's relative position with respect to the object, i.e., the ship or platform, is needed. In previous approaches, the uncertainties in both the position estimation of the object and the vehicle mean that a flight trajectory along the moving object to be inspected cannot be realized with sufficient accuracy for precise inspection. Therefore, there is a need for an improved concept for determining and/or improving a position estimation of a vehicle with respect to a moving object.

### SUMMARY

According to an embodiment, a method for determining and/or improving a position estimation of a vehicle may have the steps of: (a) determining at least three distances of the vehicle from at least three signal generators, wherein the respective distance is a distance between the vehicle and one of the at least three signal generators each; and wherein the at least three signal generators each have a predetermined position with respect to a moving coordinate system; and wherein the moving coordinate system is a coordinate system with respect to which the position of a stationary object can change due to a movement of the coordinate origin; (b) determining and/or improving the position estimation of the vehicle by using the at least three determined distances of the vehicle from the at least three signal generators and the predetermined positions of the at least three signal generators with respect to the moving coordinate system; and wherein step (a) may have the steps of: emitting a transmit signal from the vehicle to the at least three signal generators; and receiving a response signal from the at least three signal generators by the vehicle; and wherein determining the at least three distances of the vehicle from the at least three signal generators is performed based on the received response signal; and wherein steps (a) and (b) are performed by the vehicle.

Another embodiment may have a vehicle or module for a vehicle, configured to emit a transmit signal to at least three signal generators; receive a response signal from the at least three signal generators; determine at least three distances of the vehicle from the at least three signal generators based on the received response signal, wherein the respective distance is a distance between the vehicle and one of the at least three signal generators each, and wherein the at least three signal generators each have a predetermined position with respect to a moving coordinate system; and wherein the moving coordinate system is a coordinate system with respect to which the position of a stationary object can change due to a shift of the coordinate origin; and determine and/or improve a position estimation of the vehicle by using the at least three determined distances of the vehicle from the at least three signal generators and the predetermined positions of the at least three signal generators with respect to the moving coordinate system.

According to another embodiment, a system for determining and/or improving a position estimation of a vehicle may have: an inventive vehicle; and the at least three signal generators, wherein the at least three signal generators each have a predetermined position with respect to the moving coordinate system.

Another embodiment may have a computer program having a program code for performing the inventive method, when the program runs on a computer.

According to another embodiment, a method for determining and/or improving a position estimation of a vehicle may have the steps of: (a) determining at least three distances of the vehicle from at least three signal generators, wherein the respective distance is a distance between the vehicle and one of the at least three signal generators each; and wherein the at least three signal generators each have a predetermined position with respect to a moving coordinate system; and wherein the moving coordinate system is a coordinate system with respect to which the position of a stationary object can change due to a movement of the coordinate origin; (b) determining and/or improving the position estimation of the vehicle by using the at least three determined distances of the vehicle from the at least three signal generators and the predetermined positions of the at least three signal generators with respect to the moving coordinate system; and (d) navigating the vehicle based on the position estimation, wherein step (d) includes generating waypoints for a movement trajectory of the vehicle; wherein step (d) includes adapting the waypoints based on a movement of the moving coordinate system; wherein step (d) includes a prediction of the movement of the moving coordinate system; and wherein step (d) includes adapting the waypoints based on the predicted movement of the moving coordinate system.

Embodiments according to the present invention include a method for determining and/or improving a position estimation of a vehicle, comprising a step (a) comprising determining at least three distances of the vehicle from at least three signal generators, wherein the respective distance is a distance between the vehicle and one of the at least three signal generators each. In this regard, the at least three signal generators each comprise a predetermined position with respect to a moving coordinate system, and the moving coordinate system is a coordinate system with respect to which the position of a stationary object can change due to a movement of the coordinate origin. Further, the method includes a step (b) comprising determining and/or improving the position estimation of the vehicle by using the at least three determined distances of the vehicle from the at least three signal generators and the predetermined positions of the at least three signal generators with respect to the moving coordinate system.

Further embodiments according to the present invention include a vehicle or module for a vehicle configured to determine at least three distances of the vehicle from at least three signal generators, wherein the respective distance is a distance between the vehicle and one of the at least three signal generators each. Here, the at least three signal generators each have a predetermined position with respect to a moving coordinate system and the moving coordinate system is a coordinate system with respect to which the position of a stationary object can change due to a shift of the coordinate origin. Further, the vehicle or module is configured to determine and/or improve a position estimation of the vehicle by using the at least three determined distances of the vehicle from the at least three signal generators and the predetermined positions of the at least three signal generators with respect to the moving coordinate system.

Further embodiments according to the present invention include a system for determining and/or improving a position estimation of a vehicle, the system including the previously described vehicle and at least three signal generators, the at least three signal generators each having a predetermined position with respect to the moving coordinate system.

Further embodiments according to the present invention include a computer program having program code for performing a method according to the present invention when the program runs on a computer.

Embodiments according to the present invention are based on the core idea of determining and/or improving a position estimation of a vehicle by determining at least three distances of the vehicle from at least three signal generators. Due to the at least three distances of the vehicle from the at least three signal generators, a determination of the relative position of the vehicle from the at least three signal generators, for example by triangulation, is possible. Here, the at least three signal generators each have a predetermined position with respect to a moving coordinate system. Thus, by the at least three determined distances of the vehicle from the at least three signal generators, the relative position of the vehicle with respect to the moving coordinate system is also known. Accordingly, navigation of the vehicle with respect to the moving coordinate system can be performed. In this context, moving, with respect to the coordinate system, includes that the position of a stationary object with respect to the moving coordinate system can change due to a movement of the coordinate origin of the coordinate system. Specifically, the moving coordinate system can be associated with a moving ship, for example, such that the moving coordinate system moves with a movement of the ship with respect to global coordinates, such as GPS coordinates. Accordingly, the moving coordinate system can be a non-inertial system.

The signal generators can also have a predetermined but variable position with respect to the coordinate system. If the signal generators perform a known or, for example, measurable relative movement to the coordinate origin, a distance determination of the vehicle to the signal generators can be converted into a position with respect to the moving coordinate system by the variable but known relative position of the signal generators. In the case of a ship convoy, the signal generators could, for example, be arranged on different ships, which, however, have a known position relative to one another.

It should be noted in particular that the coordinate system can be spanned by the at least three signal generators. For example, the signal generators can have predetermined positions in the coordinate system. Thus, the coordinate system can be formed such that the first signal generator is arranged on a first, fixed position on a first axis of the coordinate system, the second signal generator is arranged on a second, fixed position on a second axis of the coordinate system, which is orthogonal to the first axis, and the third signal generator is arranged on a third axis of the coordinate system, which is orthogonal to the first and the second axis of the coordinate system. However, the signal generators can also each be assigned any position in the moving coordinate system, and the coordinate system can be spanned based on the determined positions of the signal generators.

However, for example, a moving coordinate system can be distorted or bent by a movement of the signal generators. For example, a set of signal generators can be arranged along an object, wherein this set of signal generators spans a first axis of the coordinate system, and wherein each of these signal generators has a fixed position on the spanned axis. Further signal generators can span, for example, the two further axes of a three-dimensional coordinate system. When the object is bent, the relative positions of the signal generators in global coordinates, e.g. GPS coordinates, can change relative to each other, and according to their fixed positions on the first axis of the moving coordinate system, the moving coordinate system can bend together with the bending of the object. For example, a vehicle navigating with respect to this coordinate system would then only move parallel to the first, bent axis of the moving coordinate system if it were to move parallel to the bent object. This allows a vehicle to be moved particularly efficiently relative to a moving coordinate system.

However, a change of shape of an object, with which, for example, the coordinate origin of the moving coordinate system is associated, can also be taken into account by adapting a model of the object. For example, trajectory planning can be based on a model, such as a CAD model, of the object in the moving coordinate system. A change of shape of the object, known for example by measurement, can then be mapped in the model, and based thereon, trajectory planning can be performed.

Another advantage of inventive concepts is that the vehicle can very quickly determine information on its own position. The determination of the distance to the respective signal generators can be faster than, for example, position determination by means of GPS. The speed refers to the update rate of the position information. In many applications, the update rate of the position information, e.g. via GPS, is not sufficient to track a trajectory with respect to a moving coordinate system with sufficient accuracy. In the case of a drone that is to land on a moving ship, position determination relative to the ship taking into account the rapidly time-varying position of the ship, especially with respect to the up and down motion due to waves, is advantageous. Thus, during an automated landing, it can be avoided that the drone, due to an upward movement of the ship by a wave unknown to the drone, touches down on the deck with too high an acceleration and is damaged or destroyed.

In further embodiments according to the present invention, step (a) includes transmitting a transmit signal from the vehicle to the at least three signal generators and receiving a response signal from the at least three signal generators by the vehicle. Further, determining the at least three distances of the vehicle from the at least three signal generators based on the received response signal is performed. Further, steps (a) and (b) are performed by the vehicle.

The response signal can include a plurality of individual signals so that, for example, each individual signal generator responds to the transmit signal with an individual signal. From a response signal from a signal generator, the vehicle can then determine a distance to the corresponding signal generator, for example based on a time measurement. Simply put, according to embodiments, the vehicle can transmit a transmit signal that impinges on the at least three signal generators. In response to the received transmit signal, each of the signal generators can transmit a response signal, which in turn is detected by the vehicle. The vehicle, which can have its own intelligence, for example, can evaluate the signal and calculate the travel time, and in turn calculate the distance to the respective signal generator. Further, the signal generators can also analyze the signal from the drone before sending the response signal. For example, the drone can transmit status information or information about its own position via communication with the signal generators.

In embodiments according to the present invention, the at least three signal generators each have a predetermined and invariable position with respect to the moving coordinate system. An invariable position of the signal generators with respect to the moving coordinate system results in the advantage that no relative movement between the signal generators and the moving coordinate system has to be taken into account. For example, the moving coordinate system itself can be spanned by the signal generators, which in turn have a predetermined and invariable position relative to one another, and wherein the signal generators can only move as a whole, i.e. while maintaining their predetermined and invariable position relative to one another.

According to embodiments of the present invention, a moving object can have a predetermined and invariable position with respect to the moving coordinate system, wherein a movement of the moving coordinate system corresponds to a physical movement of the object. Specifically, the object can be a moving ship, for example. The coordinate origin of the moving coordinate system can then be, for example, a point on the surface of the ship. Accordingly, when the ship moves, the moving coordinate system also moves with respect to an inertial system or, for example, global coordinates or GPS coordinates. The signal generators can then be firmly connected to the object, for example, so that they have the previously declared predetermined and invariable position with respect to the coordinate system. However, in the case of the object as a ship, the signal generators can also be located on one or more escort ships whose relative position to the moving ship, on the surface of which the coordinate origin of the moving coordinate system is fixed, is known. By coupling between the motion of the object and the motion of the moving coordinate system, navigation of the vehicle with respect to the moving object can be performed by determining its position relative to the moving coordinate system.

In embodiments according to the present invention, step (a) additionally includes obtaining GPS information about the position of the moving object, and step (b) includes determining and/or improving the position estimation of the vehicle by using the GPS information. By using GPS information, regarding the position of the moving object, for example, a relative position of the vehicle from the object determined by the three distances of the vehicle from the signal generators can be converted into GPS coordinates. This option of determining the position of the vehicle in global coordinates can have, for example, particular advantages if the position of the moving object in GPS coordinates is available with a higher accuracy than the position of the vehicle in GPS coordinates. For example, a ship as a moving object can have a more precise positioning system for determining its own position than, for example, a drone that can form the vehicle. In contrast, the distance determination by the signal generators is possible with a high accuracy. Thus, for example, in the case of a drone, precise position determination can be performed at low cost and with little effort. If the drone is used, for example, only in the close range around an object that comprises the signal generators, a GPS system of the drone can be omitted entirely, for example, which can result in cost advantages.

According to embodiments of the present invention, the position estimation is a position estimation with respect to the moving coordinate system or a position estimation with respect to an absolute coordinate system. Thereby, the absolute coordinate system can be at least approximately an inertial system. The absolute coordinate system can be, for example, a coordinate system in global coordinates, which uses, for example, GPS coordinates. However, the position estimation can also be performed in particular with respect to the moving coordinate system and with respect to the absolute coordinate system. This provides the vehicle with absolute position information on the one hand, for example to avoid collision with known, e.g. mapped, obstacles in the environment, and relative position information on the other hand, for example to be able to inspect a moving object with small distances.

According to embodiments of the present invention, the method can comprise an additional step (c). In this case, step (c) includes determining GPS information about the position of the vehicle, and determining and/or improving the position estimation of the vehicle by using the GPS information about the position of the vehicle. Thus, for example, data fusion can be performed in which, on the one hand, the determined GPS information about the position of the vehicle, and, on the other hand, the relative position of the vehicle with respect to the moving coordinate system are fused. Furthermore, if the GPS coordinates of the coordinate origin of the moving coordinate system are known, the information about the relative position of the vehicle with respect to the moving coordinate system can be converted into GPS coordinate information. This information can then, for example, also in turn be fused with the GPS information about the position of the vehicle to provide an improvement in the position estimation of the vehicle. Here, a GPS system can, for example, be accommodated in the vehicle itself.

In embodiments according to the present invention, step (c) is performed when the vehicle is at least at a first distance to the moving object, and steps (a) and (b) are performed when the vehicle is at a distance from the moving object that is less than the first distance. The first distance can be, for example, the range for signal transmission between vehicle and signal generators. It can be 10 km, for example. Simply put, for example, outside the range of the signal generators, navigation of the vehicle can be performed solely based on the determined GPS information about the position of the vehicle, and within the range solely based on, for example, precisely determined distances of the vehicle from the at least three signal generators and the information about the position of the signal generators with respect to the moving coordinate system. For example, in the case of a grid search by means of drones around a ship, position determination of the drones by means of GPS in a long range around the ship can be sufficient, and, for example, for an automated landing, the more precise position determination and the determination of a relative position with respect to the ship by the distance determination has to be used.

According to embodiments of the present invention, step (c) is performed when the vehicle is at least at a first distance from the moving object and steps (a), (b) and (c) are performed when the vehicle is at a distance from the moving object that is less than the first distance. Accordingly, the determination of the GPS information about the position of the vehicle can also be continued additionally, within the range of the signal generators, to provide an improved position estimation of the vehicle, for example by the data fusion explained above. Thus, a position estimation of the vehicle can be precisely determined or improved.

According to further embodiments of the present invention, the method comprises an additional step (d), wherein the step (d) comprises navigating the vehicle based on the position estimation. The improved position estimation can reduce the likelihood of collision and, for example, with respect to inspection tasks, a shorter distance can be taken to the subject or object to be inspected to improve an inspection accuracy. Accordingly, embodiments according to the present invention include concepts for setting up GPS-independent positioning systems by triangulation, based on the coordinates of the signal generators, for example based on the coordinates of installed radio beacons. This can enable navigation accurate to the centimeter. According to embodiments, the navigation can be based on the determined distances to the signal generators and replace GPS coordinates, or distance information can be combined with GPS data, e.g., the GPS coordinates can be corrected thereby. Furthermore, it is also possible to switch back and forth between GPS or GPS navigation and navigation based on the distance information from the signal generators or signal generator information. These navigation options can be used in any combination, e.g., for autonomous control of the vehicle, e.g., for autonomous flight, e.g., of a drone.

According to embodiments of the present invention, step (d) includes generating waypoints for a movement trajectory of the vehicle and adapting the waypoints based on a movement of the moving coordinate system. For example, for a landing approach of a drone to a ship, the movement trajectory of the landing approach can be adapted with respect to the movement of the ship. This allows the vehicle to navigate with increased safety, especially in the immediate vicinity of a moving object.

According to embodiments of the present invention, step (d) includes predicting the movement of the moving coordinate system and adapting the waypoints based on the predicted movement of the moving coordinate system. For movement prediction, for example, the signal generators and/or the object can be equipped with sensor elements to detect a movement of the moving coordinate system. Specifically, the signal generators can, for example, again be fixedly mounted on an object with respect to which the moving coordinate system is spanned. By using gyroscopes and accelerometers, for example in the signal generators or in the object itself, a movement of the object and thus of the moving coordinate system can be both detected and predicted. Accordingly, a trajectory of the vehicle can be adapted according to the predicted movement of the coordinate system, or object. For example, again for the case of a ship, an up and down movement due to waves can thus be predicted so that, for example, an automated landing approach of a drone as a vehicle can be planned such that the drone lands in a downward movement of the ship in an automated manner. This can prevent, for example, an unforeseen upward movement of the ship due to a wave from causing the drone to land hard on the deck of the ship and be damaged or destroyed.

According to embodiments of the present invention, step (d) includes fully automated take-off and/or landing on the moving object. For this purpose, for example, the previously explained adaptation of the movement trajectory of the vehicle can be used. By predicting the movement of the object, the fully automated take-off and/or landing can thus be performed without or, for example, with little risk of collision or excessive accelerations on the vehicle. For the take-off and/or landing on the moving object, however, environmental information, for example about wind, humidity, temperature, can also be taken into account in addition to position and movement information of the vehicle or the object.

Accordingly, according to embodiments, fully automated takeoff and/or a fully automated landing of/on moving objects can be performed by tracking the movement of the object. In the case of a moving ship as an object, for example, a compensation of wave movements can take place or can be carried out. Also, for example, when inspecting offshore wind turbines with supply ships in a swell, compensation of the wave movement can take place, wherein the at least three signal generators, for example in the form of at least three radio beacons, can be installed on the landing site. During take-off and/or landing, the vehicle, e.g. a drone, can switch its positioning or navigation to an inventive concept or system, e.g. comprising the at least three beacons, and/or use corrected GPS data, e.g. by a conversion by means of local intelligence, e.g. by means of a processing unit which is part of the vehicle.

According to embodiments of the present invention, the moving object is a ship, a zeppelin, an oil or gas platform, an offshore wind turbine, or a skyscraper. However, regardless of the type of object, bending of the entire object can also be considered. For example, skyscrapers can experience bending due to strong winds, such that the top of the skyscraper can sway by a few meters. For example, with respect to such use cases, an object can have a plurality of sensors by which bending of the object can be determined. For example, the sensors can be located at specific intervals along a surface of the object and can determine bending of the object. The bending of the object can then be mapped, for example, by adapting the model of the object in the moving coordinate system, or the coordinate system itself can be bendable, for example. Accordingly, the coordinate axes of the moving coordinate system can be associated with the surface of the bending object, such as being aligned with the surface of the bending object. In simple terms, a coordinate system could follow a bending of its associated object. In contrast, a floating oil or gas platform, for example, can move laterally without bending due to wave action. Furthermore, it should be noted that the prediction of a movement of the object can also include a prediction of a bending of the object. For example, the bending of the top of a skyscraper in strong winds can be predicted for a landing of an autonomous helicopter, e.g. by adapting the landing trajectory.

According to further embodiments of the present invention, the at least three signal generators comprise at least one of a radio beacon, a light beacon, and/or a sound beacon. According to embodiments, a plurality of signals are possible, which are exchanged between the vehicle and the signal generators. Accordingly, technically favorable signaling can be used depending on the application. Radio beacons can operate, for example, with radio waves with a frequency of 5 GHz, or, for example, 4 GHz, or a frequency or frequency range in the range of 2.4 GHz to 9.5 GHz, for example, in the range of 2.4 GHz or, for example, in the range of 4 GHz or, for example, in the range of 5 GHz. The vehicle can operate in a corresponding frequency range. More generally, the vehicle and signal generator can be tuned to corresponding frequency ranges so that signal exchange is possible.

According to embodiments of the present invention, the vehicle is a drone, a submarine, a helicopter, an airplane, a zeppelin or a ship. Accordingly, navigation with respect to a moving coordinate system can be used for a variety of applications.

According to embodiments of the present invention, an inventive system includes a moving object, for example the moving object described above, wherein the moving object has a predetermined and invariable position with respect to the moving coordinate system, and wherein a movement of the moving coordinate system corresponds to a physical movement of the object. An inventive system including the vehicle, the signal generators, and the moving object enables efficient and precise navigation of the vehicle relative to the object.

### BRIEF DESCRIPTION OF THE DRAWINGS

Embodiments of the present invention will be detailed subsequently referring to the appended drawings, in which:

FIG. 1 is a schematic illustration of a vehicle, three signal generators, and a moving coordinate system for use with methods according to embodiments of the present invention;

FIG. 2 is a schematic illustration of a system including a vehicle and three signal generators, as well as a moving coordinate system and a moving object according to embodiments of the present invention;

FIG. 3 is a schematic illustration of a navigation system of a vehicle according to embodiments of the present invention;

FIG. 4 is a flow diagram of a process according to embodiments of the present invention;

FIG. 5 is a schematic illustration of a skyscraper as an object, wherein, according to embodiments of the present invention, bending of the object is mapped with the moving coordinate system; and

FIG. 6 is a schematic overview of information processing for determining and/or improving a position estimation of a vehicle according to embodiments of the present invention.

### DETAILED DESCRIPTION OF THE INVENTION

Before embodiments of the present invention will be explained in detail below with reference to the drawings, it should be noted that identical, functionally equal or equal elements, objects and/or structures are provided with the same or similar reference numbers in the different figures, so that the description of these elements illustrated in different embodiments is interchangeable or interapplicable.

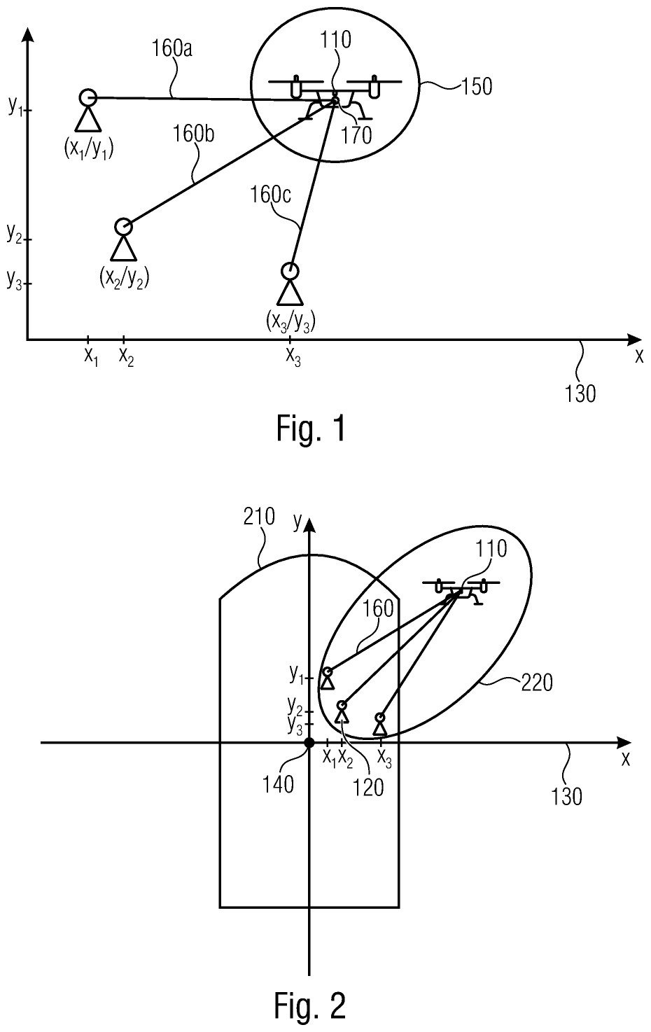

FIG. 1 shows a schematic illustration of a vehicle, three signal generators, and a moving coordinate system for use with methods according to embodiments of the present invention. FIG. 1 shows a vehicle 110, as an example in the form of a drone, signal generators 120a-c, and a moving coordinate system 130 with a coordinate origin 140.

Optionally, GPS information about the position of the vehicle can be determined. A position estimation of the vehicle 110 can be made, for example, in relative or absolute coordinates, for example, with respect to an inertial or non-inertial system, for example, with respect to global coordinates, for example, GPS coordinates, or with respect to the moving coordinate system. In the case of known GPS information about the position of the vehicle, an uncertainty of a position estimation of the vehicle 150 is illustrated in FIG. 1.

By determining the distances 160a-c of the vehicle 110 from the signal generators 120, a position of the vehicle 110 can be determined or a position estimation of the vehicle 110 can be improved. The uncertainty of an improved position estimation 170, taking into account the determined distances 160a-c, is also plotted in FIG. 1. Such an uncertainty can thereby optionally be determined, for example, taking into account uncertainties in the distance determination. According to embodiments, however, a position of the vehicle can also be determined without determining an uncertainty or a confidence interval.

The signal generators 120a-c each have a predetermined position (x₁/y₁)−(x₃/y₃) with respect to the moving coordinate system. Thus, the determined distances 160a-c can be used to determine the position of the vehicle 110 with respect to the moving coordinate system 130. Furthermore, the positions of the signal generators can also be positions with respect to an absolute coordinate system, for example global coordinates, so that the position of the vehicle 110 in global coordinates or absolute coordinates can also be determined based thereon.

A method according to the invention can further optionally include determining GPS information about the position of the vehicle. The position estimation can be performed, for example, in relative or absolute coordinates, for example, with respect to an inertial or non-inertial system.

Optionally, for determining the distances 160a-c, the vehicle 110 can emit a transmit signal that is detected by the signal generators 120a-c. The signal generators 120a-c then transmit a response signal that is received by the vehicle 110. The determination of distances 160a-c can then subsequently be performed based on the response signal, which can comprise, for example, a set of partial signals from one of the signal generators 120a-c each. The distance determination can be performed, for example, by time measurement. For example, the distance can be determined by the time period between transmitting the transmit signal and receiving the response signal.

The predetermined position of the signal generators with respect to the coordinate system 130 includes the fact that the positions (x₁/y₁)−(x₃/y₃) are known. However, these positions need not necessarily be invariable. The signal generators 160a-c can also have predetermined and invariable positions (x₁/y₁)−(x₃/y₃) with respect to the moving coordinate system 130.

FIG. 2 shows a schematic illustration of a system including a vehicle and three signal generators, as well as a moving coordinate system and a moving object according to embodiments of the present invention. FIG. 2 shows the elements already described in FIG. 1, as well as additionally an object 210. The system 220 includes the vehicle 110 and the signal generators 120.

Optionally, the system can additionally include the object 210. The object can be a ship, for example. As shown in FIG. 2, the signal generators 120 can be mounted on the object. Further, the coordinate system 130 is spanned based on a surface of the object 210. A movement of the moving coordinate system 130 thus corresponds to a physical movement of the object 210. The signal generators 120 each have a predetermined and invariable position with respect to the coordinate system 130. By determining the distances 160, the vehicle 110 can be navigated very close to the object 210 or, for example, can take-off or land automatically, since a risk of collision with the object 210 can be kept low by an inventive determination of the position relative to the coordinate system and thus the object.

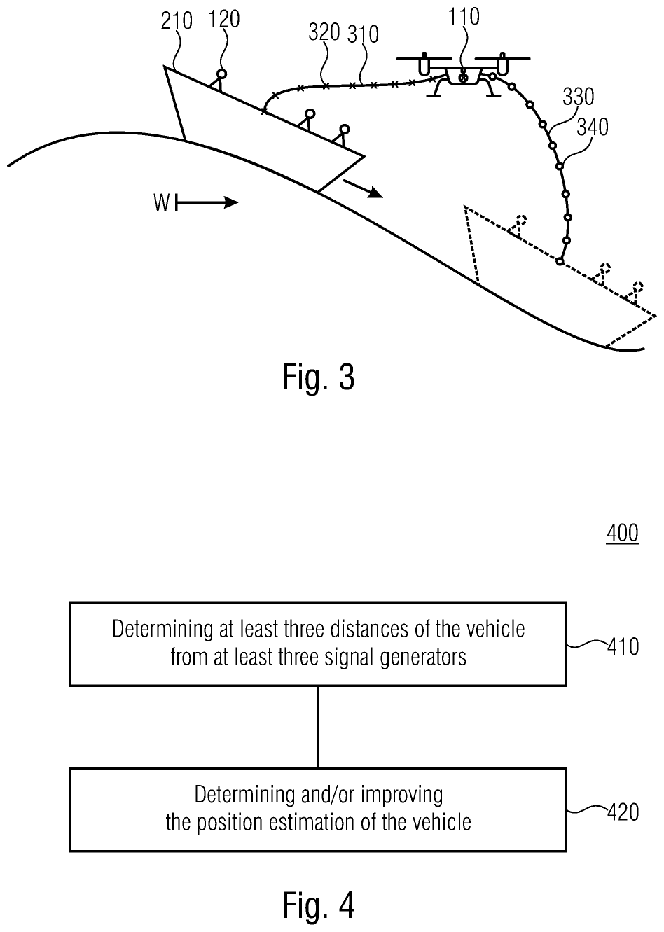

Further, GPS information about the position of the object 210 can optionally be obtained or determined. This information can then be used to improve the position estimation of the vehicle 110. If the moving coordinate system 130 is spanned based on an object surface as shown in FIG. 3, the GPS position of the object 210 can also be used to infer a GPS position of the vehicle by evaluating the distances from the vehicle 110 to the signal generators 120.

Further, GPS information about the position of the vehicle 110 can optionally be determined. Using this GPS information, for example a GPS coordinate with an uncertainty of the estimation, as shown in FIG. 1 with circle 150, determining and/or improving the position estimation of the vehicle 110 can be performed.

In this regard, the GPS information about the position of the vehicle 110 can be used alone, for example, outside of a communication range between the signal generators and the vehicle, to navigate the vehicle 110. Within a communication range, the GPS information can be used as additional information for data fusion along with the determined distances 160 of the vehicle 110 to the signal generators 120 for position determination/improvement, or it can be switched to navigation using the determined distances 160 alone.

FIG. 3 shows a schematic illustration of a navigation of a vehicle according to embodiments of the present invention. FIG. 3 shows a landing approach of the vehicle 110 to an object 210. As an example, the vehicle 110 is shown as a drone, and the object 210 is shown as a ship. Based on the position estimation of the vehicle 110, a movement trajectory 310 comprising waypoints 320, for example for landing, can be planned. When the object 210 is moving, for example as shown in FIG. 3, on a moving wave W, the waypoints can be adapted based on a movement of the moving coordinate system, or the moving object 210. In particular, this adaptation can be performed based on a prediction of a movement of the moving coordinate system, such that, as shown in FIG. 3, the vehicle 110, for example taking into account its own flight time, adapts the trajectory 310 to a trajectory 330 comprising the waypoints 340 to land on the object taking into account the movement of the object 210. As a result, such a landing or, for example, a takeoff can be fully automated.

Sensor data can be used for prediction. For example, the signal generators can comprise sensors, such as accelerometers or gyroscopes, or sensors can be arranged on the object. Furthermore, the prediction can also be calculated based on a CAD model of the object. The model can also be used to take into account torsion or bending of the object. For example, force sensors on the object can also be used to map a movement and/or deformation of the object, which in turn can be used to navigate a vehicle with respect to the object with high accuracy. This can be particularly advantageous for very large objects, since due to the dimensions of the object even small deformations, e.g. related to the height of a skyscraper or the length of a cargo ship, can lead to significant changes in the position of elements of the object.

FIG. 4 shows a flow diagram of a method according to embodiments of the present invention. Method 400, for determining and/or improving a position estimation of a vehicle, includes a step 410, wherein the step 410 comprises determining at least three distances of the vehicle from at least three signal generators, wherein the respective distance is a distance between the vehicle and one of the at least three signal generators each, wherein the at least three signal generators each have a predetermined position with respect to a moving coordinate system, and wherein the moving coordinate system is a coordinate system with respect to which the position of a stationary object can change due to a movement of the coordinate origin. Further, the method 400 includes a step 420, wherein step 420 comprises determining and/or improving the position estimation of the vehicle using the at least three determined distances of the vehicle from the at least three signal generators and the predetermined positions of the at least three signal generators with respect to the moving coordinate system. In this regard, steps 410 and 420 can correspond to steps (a) and (b) previously explained.

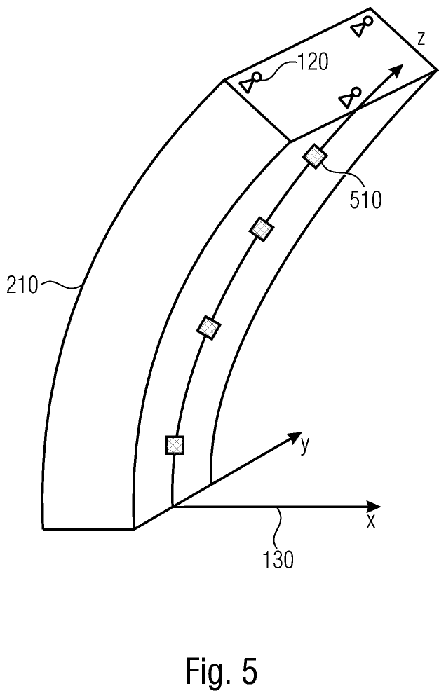

FIG. 5 shows a schematic illustration of a skyscraper as an object, wherein, according to embodiments of the present invention, bending of the object is mapped with the moving coordinate system. FIG. 5 shows an object 210 as an example in the form of a skyscraper. Due to winds, the top of a skyscraper can sway by a few meters. This effect is strongly exaggerated in FIG. 5. Signal generators 120 are arranged on the object 210. The moving coordinate system 130 is spanned by a surface of the object. The object further comprises sensors 510, which are arranged on a surface of the object 210. As an example, the sensors 510 are arranged here on an axis of the moving coordinate system 130, but they can also be arranged in any position relative to the moving coordinate system 130. The sensors 510 are configured to detect bending of the object 210. Based on a measured bending, the moving coordinate system 130 follows the surface of the object 210. A drone can now be navigated, for example for an inspection, with respect to a distance from the bent axis without colliding with the bent object 210. Such bending can also be accounted for in a corresponding model of the object 210. Such consideration of an object deformation can be used, for example, to navigate a vehicle 110 relative to rotor blades of a wind turbine. Due to their length, the rotor blades can have a deflection that can be taken into account to avoid collisions with an inspecting drone.

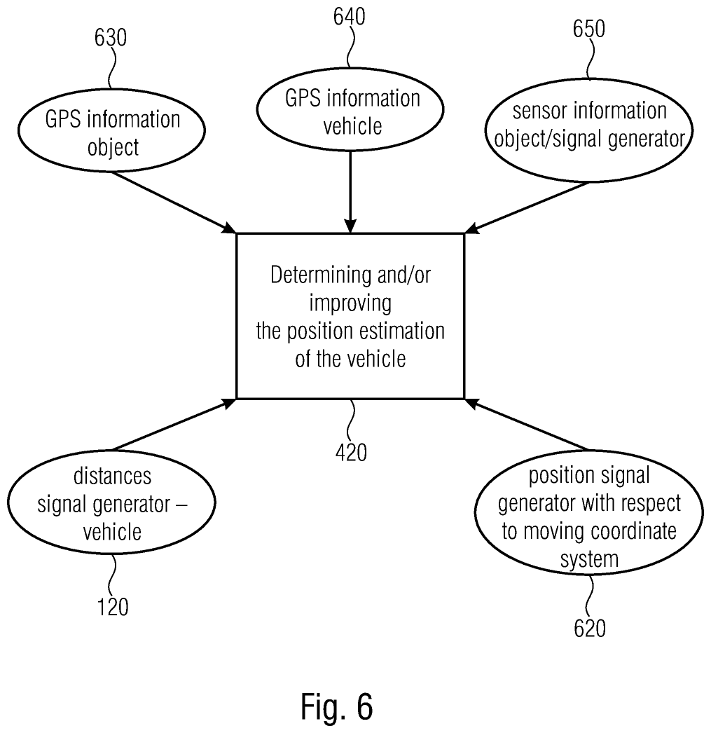

FIG. 6 shows a schematic overview of information processing for determining and/or improving a position estimation of the vehicle according to embodiments of the present invention. FIG. 6 shows step 420 of FIG. 4, which includes determining and/or improving the position estimation of the vehicle using the at least three determined distances 120 of the vehicle from the at least three signal generators and the predetermined positions 620 of the at least three signal generators with respect to the moving coordinate system, e.g., the positions (x₁/y₁)−(x₃/y₃) of FIG. 1. Additional, optional information that can be processed in step 420 can include GPS information 630 about the position of the object, GPS information 640 about the position of the vehicle, and sensor information 650 from sensors of the object and/or the signal generators. For example, the GPS information 630 about the position of the object and the GPS information 640 about the position of the vehicle can each include GPS coordinates of the object and the vehicle, respectively.

In the case of a ship as an object and a drone as a vehicle, for example, the ship can send its own GPS position 630 to the drone, and the drone can perform step 420 based on the at least three determined distances 120 of the drone from the at least three signal generators and the predetermined positions 620 of the at least one three signal generators with respect to the moving coordinate system, as well as its own position 640 determined using a GPS module.

The sensor information 650 from sensors of the object and/or the signal generator can, for example, comprise acceleration information, e.g. sensor information from acceleration or gyro sensors. If predetermined positions in the moving coordinate system are allocated to the sensors, bending of the object, for example as explained in FIG. 5, can be taken into account. It should be noted that GPS information 630 about the position of the object, GPS information 640 about the position of the vehicle, and sensor information 650 from sensors of the object and/or the signal generators can each be used individually or in any combination for step 420.

More generally, embodiments according to the present invention thus provide a concept for tracking and/or tracing objects. The objects can be traveling, driving or moving objects. For example, by correcting GPS coordinates, inspections of such objects can be performed according to the invention, for example from a supply ship, using a coming home function. The coming home function can be implemented, for example, by navigating the vehicle using the determined at least three distances of the vehicle from the at least three signal generators. The function can include, for example, an automated navigation or return to the object, as well as, for example, additionally or alternatively an automated landing function, for example with respect to a drone as a vehicle. An inspection can thus be carried out, for example, in particular from moving ships or from other moving objects, while in motion. Furthermore, according to the invention, any search patterns can be performed by the vehicle in parallel to the moving object. For example, drones can perform any search pattern, e.g., in the vicinity of the moving ship, parallel to the travel of a ship, e.g., a sea rescue ship, by converting the determined distances or distance values to correct the position estimation, e.g., GPS coordinates. Additionally or alternatively, a position estimation, e.g. in the form of GPS coordinates of the moving object, e.g. the moving ship can also be transmitted for correction of the vehicle, e.g. drone position or position estimation. In this case, only a landing or return of the vehicle can be controlled by determining the distances of the vehicle from the signal generators, for example.

More generally, embodiments according to the present invention provide concepts for inspecting moving objects. The moving objects can be, for example, anchored floating oil or gas platforms. For example, a triangulation system can be set up using the at least three signal generators, for example in the form of radio beacons, on the movable or moving object. The set up or calculation of the moving coordinate system can be based on a triangulation of the coordinates of the installed signal generators or radio beacons. Furthermore, a dynamic adaptation or conversion of the coordinates to the movement of the object can take place. For example, a change in the positions or the distance data or a change in the position can be detected by a change in the distance data of the signal generators or radio beacons. The vehicle, e.g., a drone can then follow the movements of the object or follow a predetermined movement trajectory, relative to the moving object. Further, a conversion of CAD data, e.g., of the object, into the moving coordinate system for dynamic waypoint (waypoint) generation of the vehicle, e.g., drone, can be performed, e.g., using local intelligence.

In addition, another advantage or field of application of inventive concepts is a vehicle control accurate to the centimeter, e.g. a drone flight accurate to the centimeter in areas with GPS shadowing, e.g. under bridges, industrial plants (refineries, etc.) or inside objects or buildings, e.g. indoors. By using an appropriate frequency range, e.g. in the GHz range, signals between vehicle and signal generator can penetrate obstacles such as walls.

All the lists of materials, environmental influences, electrical properties and optical properties stated herein are to be regarded as examples and not as exhaustive.

Although some aspects have been described in the context of an apparatus, it is obvious that these aspects also represent a description of the corresponding method, such that a block or device of an apparatus also corresponds to a respective method step or a feature of a method step. Analogously, aspects described in the context of a method step also represent a description of a corresponding block or detail or feature of a corresponding apparatus. Some or all of the method steps may be performed by a hardware apparatus (or using a hardware apparatus), such as a microprocessor, a programmable computer or an electronic circuit. In some embodiments, some or several of the most important method steps may be performed by such an apparatus.

Depending on certain implementation requirements, embodiments of the invention can be implemented in hardware or in software. The implementation can be performed using a digital storage medium, for example a floppy disk, a DVD, a Blu-Ray disc, a CD, an ROM, a PROM, an EPROM, an EEPROM or a FLASH memory, a hard drive or another magnetic or optical memory having electronically readable control signals stored thereon, which cooperate or are capable of cooperating with a programmable computer system such that the respective method is performed. Therefore, the digital storage medium may be computer readable.

Some embodiments according to the invention include a data carrier comprising electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer.

The program code may, for example, be stored on a machine readable carrier.

Other embodiments comprise the computer program for performing one of the methods described herein, wherein the computer program is stored on a machine readable carrier.

In other words, an embodiment of the inventive method is, therefore, a computer program comprising a program code for performing one of the methods described herein, when the computer program runs on a computer.

A further embodiment of the inventive method is, therefore, a data carrier (or a digital storage medium or a computer-readable medium) comprising, recorded thereon, the computer program for performing one of the methods described herein. The data carrier, the digital storage medium, or the computer-readable medium are typically tangible or non-volatile.

A further embodiment of the inventive method is, therefore, a data stream or a sequence of signals representing the computer program for performing one of the methods described herein. The data stream or the sequence of signals may, for example, be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment in accordance with the invention includes an apparatus or a system configured to transmit a computer program for performing at least one of the methods described herein to a receiver. The transmission may be electronic or optical, for example. The receiver may be a computer, a mobile device, a memory device or a similar device, for example. The apparatus or the system may include a file server for transmitting the computer program to the receiver, for example.

In some embodiments, a programmable logic device (for example a field programmable gate array, FPGA) may be used to perform some or all of the functionalities of the methods described herein. In some embodiments, a field programmable gate array may cooperate with a microprocessor in order to perform one of the methods described herein. Generally, the methods are performed by any hardware apparatus. This can be a universally applicable hardware, such as a computer processor (CPU) or hardware specific for the method, such as ASIC.

The apparatuses described herein may be implemented, for example, by using a hardware apparatus or by using a computer or by using a combination of a hardware apparatus and a computer.

The apparatuses described herein or any components of the apparatuses described herein may be implemented at least partly in hardware and/or software (computer program).

The methods described herein may be implemented, for example, by using a hardware apparatus or by using a computer or by using a combination of a hardware apparatus and a computer.

The methods described herein or any components of the methods described herein may be performed at least partly by hardware and/or by software (computer program).

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. Method for determining and/or improving a position estimation of a vehicle, comprising:
(a) determining at least three distances of the vehicle from at least three signal generators, wherein the respective distance is a distance between the vehicle and one of the at least three signal generators each; and
wherein the at least three signal generators each comprise a predetermined position with respect to a moving coordinate system; and
wherein the moving coordinate system is a coordinate system with respect to which the position of a stationary object can change due to a movement of the coordinate origin;
(b) determining and/or improving the position estimation of the vehicle by using
the at least three determined distances of the vehicle from the at least three signal generators and
the predetermined positions of the at least three signal generators with respect to the moving coordinate system; and
wherein step (a) comprises:
emitting a transmit signal from the vehicle to the at least three signal generators; and
receiving a response signal from the at least three signal generators by the vehicle; and
wherein determining the at least three distances of the vehicle from the at least three signal generators is performed based on the received response signal; and
wherein steps (a) and (b) are performed by the vehicle.

2. Method according to claim 1, wherein the at least three signal generators each comprise a predetermined and invariable position with respect to the moving coordinate system.

3. Method according to claim 1, wherein a moving object comprises a predetermined and invariable position with respect to the moving coordinate system and wherein a movement of the moving coordinate system corresponds to a physical movement of the object.

4. Method according to claim 3, wherein step (a) additionally comprises acquiring GPS information about the position of the moving object, and wherein step (b) comprises determining and/or improving the position estimation of the vehicle by using the GPS information.

5. Method according to claim 1, wherein the position estimation is a position estimation
with respect to the moving coordinate system or
with respect to an absolute coordinate system,
wherein the absolute coordinate system is at least approximately an inertial system.

6. Method according to claim 1, wherein the method comprises an additional step (c) wherein step (c) comprises:
determining GPS information about the position of the vehicle; and
determining and/or improving the position estimation of the vehicle by using the GPS information about the position of the vehicle.

7. Method according to claim 6, wherein step (c) is performed when the vehicle is at least at a first distance to the moving object; and
wherein steps (a) and (b) are performed when the vehicle is at a distance to the moving object, which is less than the first distance.

8. Method according to claim 6, wherein step (c) is performed when the vehicle is at least at a first distance to the moving object; and
wherein steps (a), (b) and (c) are performed when the vehicle is at a distance to the moving object that is less than the first distance.

9. Method according to claim 1, wherein the method comprises an additional step (d), wherein step (d) comprises navigating the vehicle based on the position estimation.

10. Method according to claim 9, wherein step (d) comprises generating waypoints for a movement trajectory of the vehicle; and
wherein step (d) comprises adapting the waypoints based on a movement of the moving coordinate system.

11. Method according to claim 10, wherein step (d) comprises predicting the movement of the moving coordinate system; and
wherein step (d) comprises adapting the waypoints based on the predicted movement of the moving coordinate system.

12. Method according to claim 9, wherein step (d) comprises fully automated take-off and/or landing on the moving object.

13. Method according to claim 1, wherein the moving object is a ship, a zeppelin, an oil or gas platform, and offshore wind turbine or a skyscraper.

14. Method according to claim 1, wherein the at least three signal generators comprise at least one of a radio beacon, a light beacon and/or a sound beacon.

15. Method according to claim 1, wherein the vehicle is a drone, a submarine, a helicopter, an airplane, a zeppelin or a ship.

16. Vehicle or module for a vehicle, configured to
emit a transmit signal to at least three signal generators;
receive a response signal from the at least three signal generators;
determine at least three distances of the vehicle from the at least three signal generators based on the received response signal, wherein the respective distance is a distance between the vehicle and one of the at least three signal generators each, and wherein the at least three signal generators each comprise a predetermined position with respect to a moving coordinate system; and
wherein the moving coordinate system is a coordinate system with respect to which the position of a stationary object can change due to a shift of the coordinate origin; and
determine and/or improve a position estimation of the vehicle by using
the at least three determined distances of the vehicle from the at least three signal generators and
the predetermined positions of the at least three signal generators with respect to the moving coordinate system.

17. System for determining and/or improving a position estimation of a vehicle, wherein the system comprises:
a vehicle according to claim 16; and
the at least three signal generators, wherein the at least three signal generators each comprise a predetermined position with respect to the moving coordinate system.

18. System according to claim 17, wherein the system comprises a moving object, wherein the moving object comprises a predetermined and invariable position with respect to the moving coordinate system, and wherein a movement of the moving coordinate system corresponds to a physical movement of the object.

19. Computer program having a program code for performing the method according to claim 1, when the program runs on a computer.

20. Method for determining and/or improving a position estimation of a vehicle, comprising:
(a) determining at least three distances of the vehicle from at least three signal generators, wherein the respective distance is a distance between the vehicle and one of the at least three signal generators each; and
wherein the at least three signal generators each comprise a predetermined position with respect to a moving coordinate system; and
wherein the moving coordinate system is a coordinate system with respect to which the position of a stationary object can change due to a movement of the coordinate origin;
(b) determining and/or improving the position estimation of the vehicle by using
the at least three determined distances of the vehicle from the at least three signal generators and
the predetermined positions of the at least three signal generators with respect to the moving coordinate system; and
(d) navigating the vehicle based on the position estimation,
wherein step (d) comprises generating waypoints for a movement trajectory of the vehicle;
wherein step (d) comprises adapting the waypoints based on a movement of the moving coordinate system;
wherein step (d) comprises a prediction of the movement of the moving coordinate system; and
wherein step (d) comprises adapting the waypoints based on the predicted movement of the moving coordinate system.
